(19) United States
(12) Patent Application Publication
(10) Pub. No.: US 2023/0211631 A1
(43) Pub. Date: Jul. 6, 2023

(54) SYSTEMS AND METHODS FOR WHEEL ASSEMBLIES AND SPOKES

(71) Applicant: Keir Manufacturing, Inc., Brevard, NC (US)

(72) Inventors: David WATKINS, Brevard, NC (US); James ANDERSON, Brevard, NC (US); Richard TRENT, Brevard, NC (US); Daniel ZUCCALA, Brevard, NC (US)

(21) Appl. No.: 17/996,304

(22) PCT Filed: Apr. 15, 2021
(86) PCT No.: PCT/US2021/027539

§ 371 Date: Oct. 14, 2022

Related U.S. Application Data
(60) Provisional application No. 63/010,790, filed on Apr. 16, 2020.

(51) Int. Cl. B60B 1/02; B60B 1/04

(52) U.S. Cl. CPC B60B 1/0284; B60B 1/042; B60B 1/043; B60B 1/041; B60Y 2200/13

(57) ABSTRACT

A wheel assembly including a rim including a first rim hole extending through an inner surface and an outer surface of a rim at a first angle, the first angle being defined with respect to a center line through the wheel in a direction of travel at the location of the first rim hole and with respect to an axis radially normal to the rim, the first angle having a non-zero first component relative to the center line and a non-zero second component relative to the radially normal axis, a hub including a first hub hole, the first hub hole being formed at the first angle such that the first rim hole and the first hub hole are co-axial, and a first spoke extending between the first rim hole and the first hub hole, the first spoke being co-axial with the first rim hole and the first hub hole.

### RELATED APPLICATION DATA

This application claims priority to co-pending U.S. Provisional Pat. Application No. 63/010,790, filed Apr. 16, 2020, titled “SYSTEMS, AND METHODS FOR WHEEL ASSEMBLIES AND SPOKES,” the entire disclosure of which is incorporated herein by reference.

### FIELD

The disclosure generally relates to systems, assemblies, and methods for wheel assemblies and spokes.

### BACKGROUND

Typical wheel sets and wheel assemblies may include a series of spokes that extend between a hub and a rim of the wheel. The spokes may be made of metal and may be connected between the hub and the rim via holes in the rim that are drilled at a 90° angle into the rim. Spokes may be bent in order to connect between the hub and the rim, and some spokes may interlace with each other.

The use of metal spokes may detract from attempts to lighten wheel sets. The material properties of metal spokes may also limit performance improvements, such as attempts to stiffen wheels.

Further, when interlaced metal spokes contact one another, poor performance properties, such as tensile strength and shared loads between interlaced spokes, may result.

There exists a need for improved wheel assemblies and spokes.

### SUMMARY

Embodiments of the present disclosure provide a wheel assembly including a rim including a first rim hole extending through an inner surface and an outer surface of the rim at a first angle, the first angle being defined with respect to a center line through the wheel in a direction of travel at the location of the first rim hole and with respect to an axis radially normal to the rim, the first angle having a non-zero first component relative to the center line and a non-zero second component relative to the radially normal axis, a hub including a first hub hole, the first hub hole being formed at the first angle such that the first rim hole and the first hub hole are co-axial, and a first spoke extending between the first rim hole and the first hub hole, the first spoke being co-axial with the first rim hole and the first hub hole.

Embodiments of the present disclosure also provide a wheel assembly comprising a rim comprising a first rim hole extending through the rim at a first angle, the first angle is defined with respect to a center line through the wheel in a direction of travel at the location of the first rim hole and with respect to an axis radially normal to the rim, the first angle having a first component associated with the center line and a second component associated with the radially normal axis. A hub comprising a first hub hole at the first angle such that the first rim hole and the first hub hole are co-axial. A first spoke extending between the first rim hole and the first hub hole, the first spoke comprising a carbon containing composite material.

Embodiments of the present disclosure provide a method of assembling a wheel. The method comprising providing a rim, the rim comprising a plurality of rim holes extending through the rim at a plurality of angles, each of the plurality of angles is defined with respect to an axis normal to the rim at the respective location of each of the plurality of rim holes, the plurality of angles each having a first component defined with respect to the center line and a second component defined with respect to the radially normal axis; providing a hub, the hub comprising a plurality of hub holes the plurality of angles of the rim holes such that the plurality of rim holes are each aligned with the respective hub holes; connecting a plurality of spokes at a proximal end to the plurality of hub holes; and extending each of the plurality of spokes along the angle aligning each respective hole to connect connecting the plurality of spokes at a distal end to the plurality of rim holes.

Embodiments of the present disclosure provide a wheel spoke comprising an elongated body configured to extend between a rim and a wheel hub, the elongated body comprising a high modulus carbon fiber and one or more synthetic fibers or blended fibers, a first threaded end, a second threaded end.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1A illustrates a right side view of a wheel assembly, consistent with embodiments of this disclosure;

FIG. 1B illustrates a cross-sectional view taken along line 1B-1B in FIG. 1A, consistent with embodiments of this disclosure;

FIG. 1C illustrates a detailed view of a portion of the wheel assembly shown in FIG. 1A, with portions of the wheel assembly removed, consistent with embodiments of this disclosure;

FIG. 1D illustrates a cross-sectional view taken along line 1D-1D in FIG. 1A, consistent with embodiments of this disclosure;

FIG. 1E illustrates a detailed view of a portion of the wheel assembly shown in FIG. 1A, with portions of the wheel assembly removed, consistent with embodiments of this disclosure;

FIG. 2A illustrates a detailed portioned right-side view of the wheel assembly shown in FIG. 1A;

FIG. 2B illustrates a detailed portioned perspective view of the wheel assembly shown in FIG. 1A;

FIG. 3 illustrates a detailed portioned top view of a hub assembly, consistent with embodiments of this disclosure;

FIG. 4 illustrates a detailed portioned perspective view of a hub assembly, consistent with embodiments of this disclosure;

FIG. 5 illustrates a perspective view of a spoke, consistent with embodiments of this disclosure;

FIG. 6A illustrates a top view of a front wheel assembly and a top view of a back wheel assembly, consistent with embodiments of this disclosure; and

FIG. 6B illustrates a top view of another front wheel assembly and another back wheel assembly wheel assembly, consistent with embodiments of this disclosure;

### DETAILED DESCRIPTION

As discussed in further detail below, various embodiments of wheel assemblies and spokes are provided. Embodiments of the wheel assemblies and spokes may contain spokes arranged coaxially with holes in a hub and a rim. This arrangement allows for the use of composite spokes, lightening overall wheel assembly weight and improving material properties. Spokes may travel from hub to rim in a straight line, without bending. Further, spokes may cross one another without contact, avoiding performance degradations due to interlacing. As described in more detail below, a straight alignment between a hub hole and a rim hole may eliminate stress rising points that may be generated from off-center alignment. Conventional systems may rely on bending steel spokes, which may introduce fatigue points along the spokes at positions where the spokes are bent. The straight alignment of the exemplary embodiments described here may provide a straight pull from the hub to the location on the rim, and may place all forces in direct line with the hub, thereby creating a pure tensile pull anything off alignment eliminates the pure tensile pull on the spoke. The composite materials described below also exhibit improved performance when placed in a in pure tensile setup as described.

Further, the use of carbon rims has caused an increase in accidents due to stresses imparted on bent spokes, including bent composite spokes. By eliminating stresses imparted onto bent spokes with the provided embodiments, the safety of the wheel assemblies has also been improved.

These and other aspects of the disclosed embodiments are discussed in more detail below.

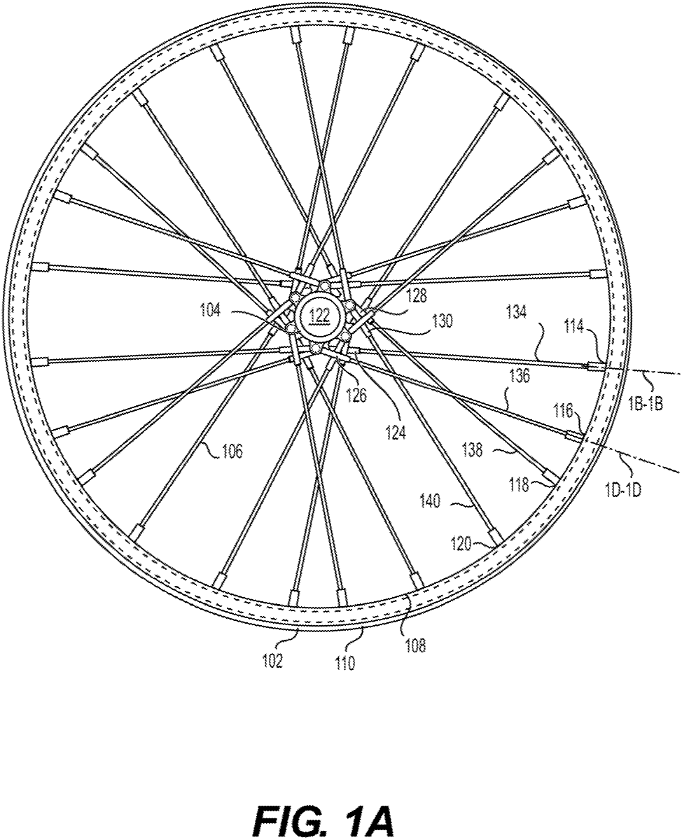

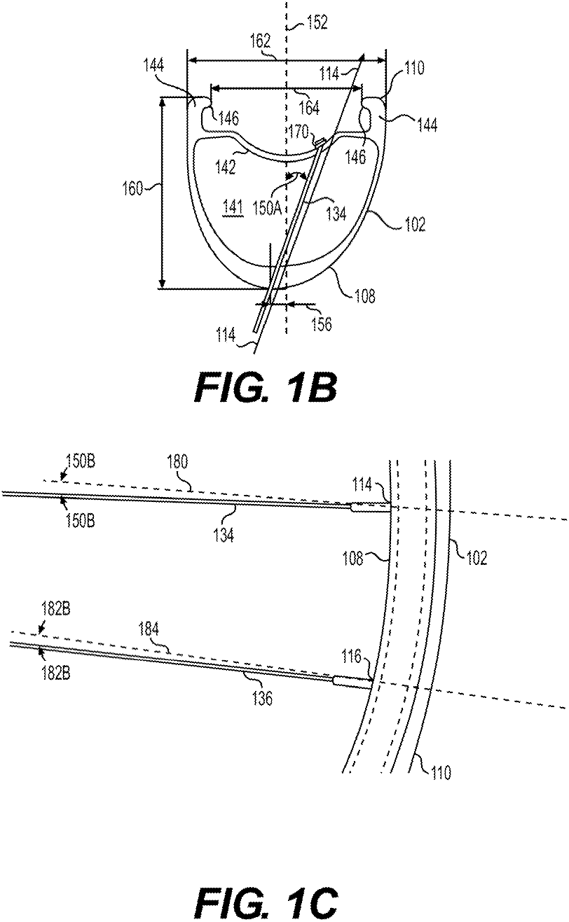

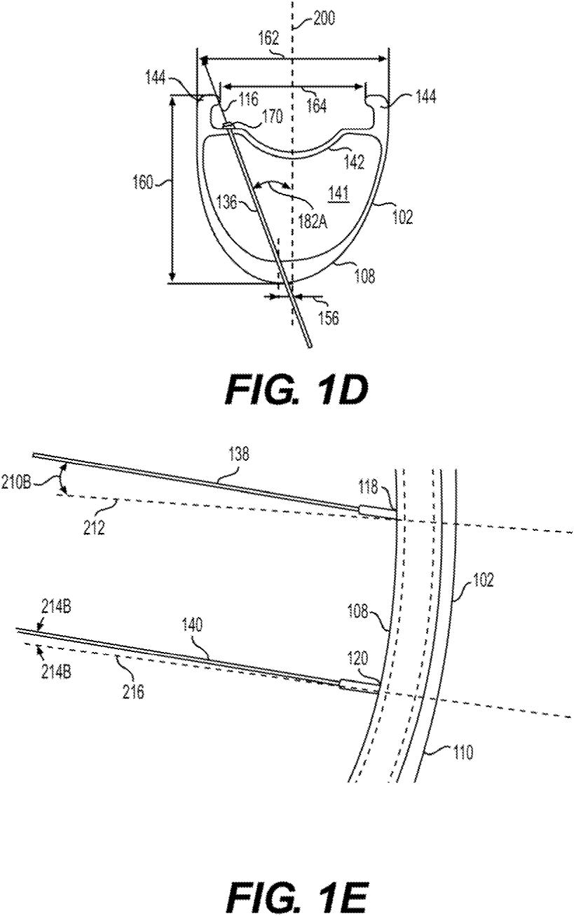

FIG. 1A illustrates an embodiment of a wheel assembly 100. The wheel assembly may include a rim 102 having one or more holes, a hub 104 having one or more holes, and one or more spokes (e.g. spoke 106) extending between the hub 104 and the rim 102.

The rim 102 may include an inner surface 108 and an outer surface 110, the inner surface facing an interior portion of the wheel assembly 100, and the outer surface 110 facing an externally away from the rest of the wheel assembly 100. The rim 102 may be round, and may include a plurality of rim holes specifically positioned and at specific angles through the rim. The rim 102 may include any suitable number of rim holes. For purposes of discussion, rim 102 may include a first rim hole 114, a second rim hole 116, a third rim hole 118, and a fourth rim hole 120. The rim 102 may include additional rim holes beyond rim holes 114, 116, 118, and 120 For example, rim 102 may include rim holes spaced apart around the circumference of the rim 102. Exemplary rim holes (e.g. rim holes 114, 116, 118, and 120) will be discussed in more detail in reference to FIGS. 1B, 1C, 1D, and 1E.

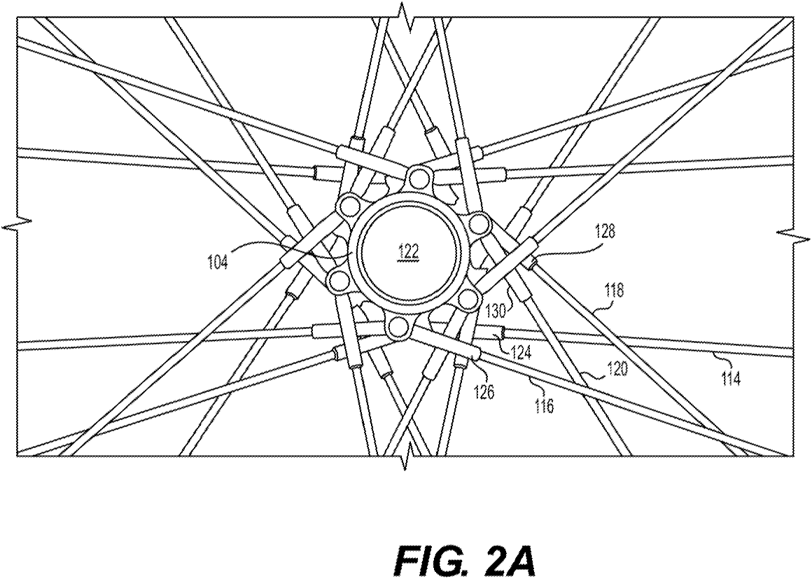

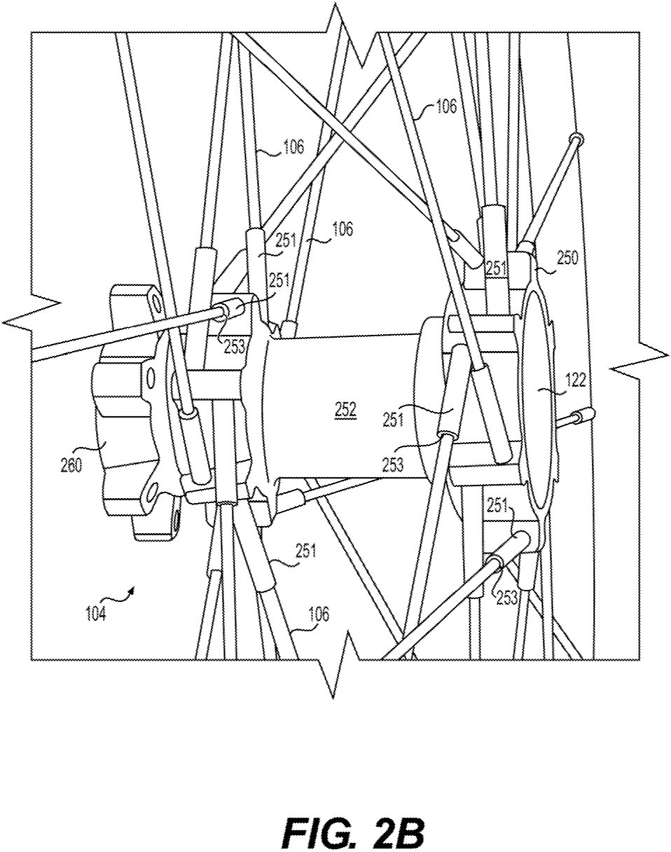

The hub 104 may be centrally positioned within the wheel assembly 100 and may include a cylindrical internal chamber 122. The hub 104 may include flanges extending radially away from the cylindrical internal chamber 122, each flange may have a plurality of hub holes positioned around the circumference of the flange. The plurality of hub holes may be co-axially aligned with the plurality of rim holes such that each hub hole co-axially aligns with a respective rim hole. For example, hub 104 may have a first hub hole 124, a second hub hole 126, a third hub hole 128, and a fourth hub hole 130. The first rim hole 114 and the first hub hole 124 may be coaxially aligned, the second rim hole 116 and the second hub hole 126 may be coaxially aligned, the third rim hole 118 and the third hub hole 128 may be coaxially aligned, and the fourth rim hole 120 and the fourth hub hole 130 may be coaxially aligned. Exemplary hub holes (e.g. hub holes 124, 126, 128, and 123) will be discussed in more detail in reference to FIG. 2A.

Additionally, wheel assembly 100 may have a first spoke 134, a second spoke 136, a third spoke 138, and a fourth spoke 140. The first spoke 134 may be positioned coaxially with and extend between the first rim hole 114 and the fist hub hole 124. The second spoke 136 may be positioned coaxially with and extend between the second rim hole 116 and the second hub hole 126. The third spoke 138 may be positioned coaxially with and extend between the third rim hole 118 and the third hub hole 128. The fourth spoke 140 may be positioned coaxially with and extend between the fourth rim hole 120 and the fourth hub hole 130.

FIG. 1B illustrates a cross-sectional view through rim 102, taken along line 1B-1B in FIG. 1A. Rim 102 may have a hollow internal chamber 141 positioned between the inner surface 108 and the outer surface 110 that extends around the circumference of the rim 102. The internal chamber 141 may have a recessed outer surface 142 that partially protrudes into internal chamber 141. In some embodiments, the recessed outer surface 142 may provide space for an internal portion of a tube element (not shown) that may be inflated to extend away from recessed outer surface 142 and outer surface 110. The rim 102 may further include opposing flanges 144 that extend to the outer surface 110. Each opposing flange 144 may include a lip surface 146 that extends internally, the opposing flanges 144 and associated lip surfaces 146 may be configured to receive and retain a bead core and a tire casing that may be positioned around the rim.

FIG. 1B illustrates the positioning of the first rim hole 114 through the cross section of rim 102. The first rim hole 114 may extend through the inner surface 108 and the outer surface 110 via recessed outer surface 142 of the rim 102 at a first angle 150, the first angle 150 may be defined with respect to a center line 152 through the rim 102 in a direction of travel at the location of the first rim hole 114. FIG. 1B illustrates the first component 150A of first angle 150. The first rim hole 114 may have a first component associated with the center line 152, where the angle 150A of the first rim hole 114 is measured with respect to the center line 152. In a non-limiting example, the first component 150A of the first angle 150 may be between 3.5° and 7°, and more specifically the first component 150A of the first angle 150 may be between 3.5° and 7° to the right of centerline 152.

The first rim hole 114 may be offset from the center line 152 at an offset distance 156. As illustrated, offset distance 156 may extend to the left of center line 152. The first rim hole 114 may begin at the offset distance 156 and extend along first angle 150A through the inner surface 108, and may continue along angle 150A, across center line 152, and through recessed outer surface 142. In other embodiments, offset distance 156 may extend to the right of center line 152.

The first spoke 134 may be positioned through the first rim hole 114 and may extend through the first rim hole 114 in the inner surface 108, through the inner chamber 141 and through the first rim hole 114 in the recessed outer surface 142. First spoke 134 may extend between first rim hole 114 and first hub hole 124 along first angle 150A that coaxially aligns the first rim hole 114 and the first hub hole 124.

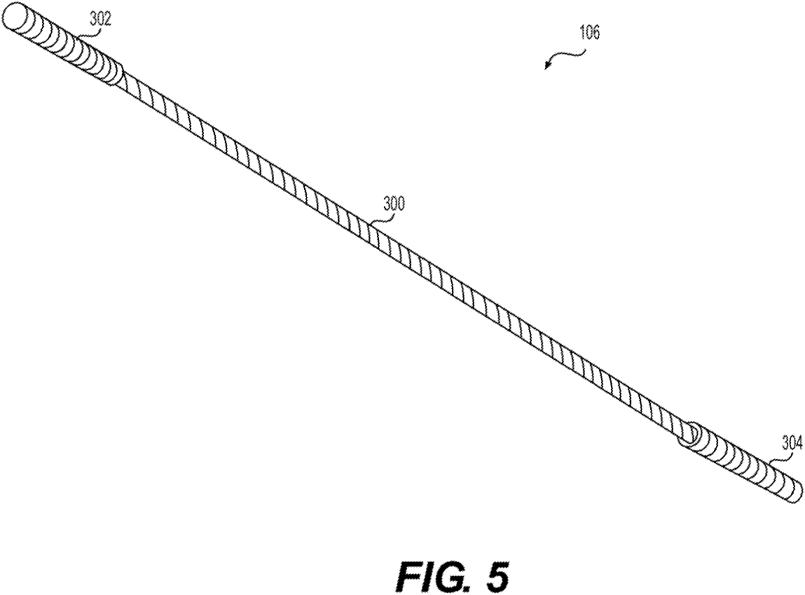

The first spoke 134 may be secured at the recessed outer surface 142 with a fastener 170. The fastener 170 may take any suitable form that may removably secure the first spoke 134 to the rim 102. In some embodiments, the first spoke 114 (and spokes 106, 136, 138, 140) may have a threaded end section (see FIG. 5). The fastener 170 may be configured to engage with the threaded end of the first spoke 134. Non-limiting examples of fasteners 170 include bolts, external nipples that thread onto the spoke, nuts, or any other suitable fastener. In some embodiments, threads on first spoke 134 may engage with threads formed inside of hole 114 as it passes through inner surface 108 or outer surface 142. In some embodiments, fastener 170 may be disposed within internal chamber 141, between inner surface 108 and outer surface 142.

Rim 102 may have dimensions including a rim depth 160 measured between the inner surface 108 and the outer surface 110, an outer rim width 162 measured between the outer surfaces of the opposing flanges 144, and an inner rim width 164 measured between the inner surfaces of the opposing flanges 144. -In some non-limiting embodiments, the rim depth 160 may be between 25 mm and 50 mm. In some embodiments, the rim depth 160 may be 28 mm, 36 mm, or 46 mm. In some non-limiting embodiments, the inner rim width 164 may be between 15 mm and 35 mm. In some embodiments, the inner rim width 164 may be 21 mm, 22 mm, 25 mm, or 30 mm. Some embodiments may include, for example, rims that are 23 mm deep and 25 mm wide, 25 mm deep and 30 mm wide, 36 mm deep and 21 mm wide, 46 mm deep and 21 mm wide, or 28 mm deep and 22 mm wide. Each of these rims may be approximately 29 inches in outer diameter. FIG. 1C illustrates a detailed view of a portion of the wheel assembly 100 shown in FIG. 1A, with portions of the wheel assembly 100 removed. FIG. 1A illustrates the first rim hole 114 and a portion of the first spoke 134 and the second rim hole 116 and a portion of the second spoke 136.

As illustrated in FIG. 1C, first angle 150 may also be defined with respect to an axis 180. Axis 180 is radially normal to the rim 102 at the location of the first rim hole 114. Axis 180 may pass through the rim 102 at the location of the first rim hole and extend through the first hub hole 124. In some embodiments, axis 180 may pass through the rim along center line 152 such that axis 180 and center line 152 are aligned. The first angle 150 has a second component 150B associated with the axis 180 radially normal to the rim 102 at the location of the first rim hole 114. The angle 150B of the first rim hole 114 is measured with respect to axis 180. In a non-limiting example, the second component 150B of the first angle 150 may be between 3.8° and 4.7°, and more specifically the second component 150B of the first angle 150 may be between 3.8° and 4.7° aft with respect to axis 180.

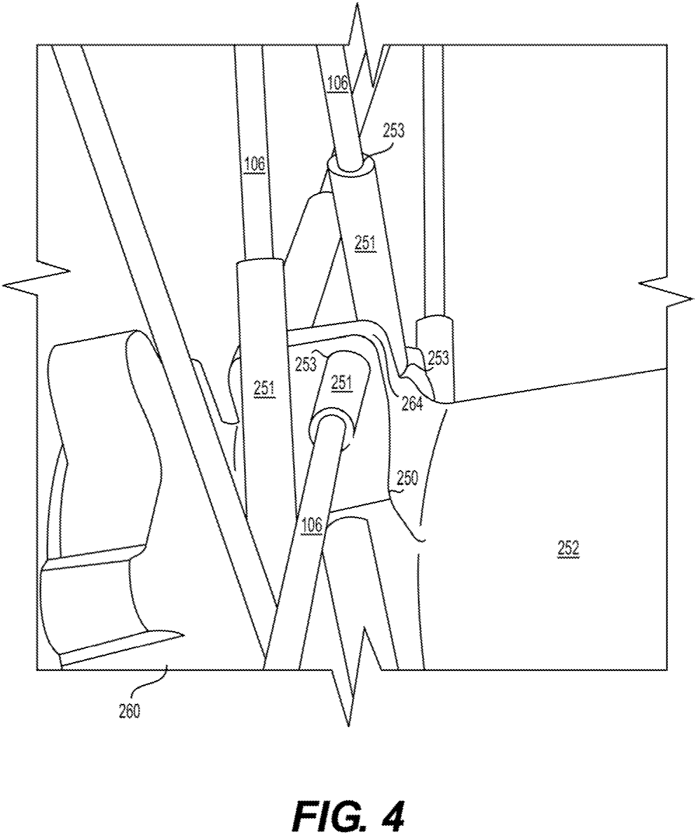

First spoke 134 may extend between first rim hole 114 and first hub hole 124 (see FIG. 2A) along first angle 150 that coaxially aligns the first rim hole 114 and the first hub hole 124. Accordingly, first angle 150 may have a second component 150B as shown in FIG. 1C and a first component 150A as shown in FIG. 1B. The first rim hole 114 and the first hub hole 124 may be coaxially aligned in along first angle 150 such that the first rim hole 114 and the first hub hole 124 share second and first components with respect to axis 180 and center line 152, respectively. In this embodiment, first rim hole 114 is formed at an angle that is not perpendicular to rim 102 and first hub hole 124 is formed at an angle that is not perpendicular to hub flange 250 (see FIGS. 2B and 4). When first rim hole 114 and first hub hole 124 are coaxial, first spoke 134 may pass through rim hole 114 and hub hole 124 without bending. This may allow, for example, for the use of a lighter, stiffer spoke.

FIG. 1C also illustrates a second angle 182 that is defined with respect to an axis 184 radially normal to the rim 102 at the location of the second rim hole 116. Similar to first angle 150, second angle 182 may have first and second components 182A and 182B. Second component 182B associated with the axis 184 radially normal to the rim 102 at the location of the second rim hole 116. The angle 182B of the second rim hole 116 is measured with respect to axis 184. In a non-limiting example, the second component 182B of the second angle 182 may be between 3.8° and 4.7°, and more specifically the second component 182B of the second angle 182 may be between 3.8° and 4.7° aft with respect to axis 184.

Second spoke 136 may extend between second rim hole 116 and second hub hole 126 along second angle 182 that coaxially aligns the second rim hole 116 and the second hub hole 126 (see FIG. 2A). Accordingly, second angle 182 may have a second component 182B as shown in FIG. 1C.

FIG. 1D illustrates a cross-sectional view through rim 102, taken along line 1D-1D in FIG. 1A, and illustrates the positioning of the second rim hole 116 through the cross section of rim 102. The second rim hole 116 may extend through the inner surface 108 and the outer surface 110 via recessed outer surface 142 of the rim 102 at the second angle 182, the first component 182A of second angle 182 may be defined with respect to a center line 200 through the rim 102 in a direction of travel at the location of the second rim hole 116. FIG. 1B illustrates the first component 182A of second angle 182. The second rim hole 116 may have a first component 182A associated with the center line 200, where the second angle 182 of the second rim hole 116 is measured with respect to the center line 200. In a non-limiting example, the first component 182A of the second angle 182 may be between 1.5° and 5.5°, and more specifically the first component 182A of the second angle 182 may be between 1.5° and 5.5° to the left of centerline 200.

The second rim hole 116 may be offset from the center line 200 at offset distance 156. As illustrated, offset distance 156 may extend to the left of center line 152. The second rim hole 116 may begin at the offset distance 156 and extend along second angle 182 through the inner surface 108, and may continue along angle 182, and through an external portion of recessed outer surface 142. In other embodiments, offset distance 156 may extend to the right of center line 152.

The second spoke 136 may be positioned through the second rim hole 116 and may extend through the second rim hole 116 in the inner surface 108, through the inner chamber 141 and through the second rim hole 116 in the external portion of recessed outer surface 142. Second spoke 136 may extend between second rim hole 116 and second hub hole 126 (see FIG. 2A) along second angle 182 that coaxially aligns the second rim hole 116 and the second hub hole 126. The second spoke 136 may be secured at the external portion of recessed outer surface 142 with a fastener (for example fastener 170).

Accordingly, the second angle 182 may have a second component 182B as shown in FIG. 1C and a first component 182A as shown in FIG. 1D. The second rim hole 116 and the second hub hole 126 may be coaxially aligned in along second angle 182 such that the second rim hole 116 and the second hub hole 126 share second 182B and first 182A components with respect to axis 182 and center line 200, respectively.

FIG. 1E illustrates a detailed view of a portion of the wheel assembly 100 shown in FIG. 1A, with portions of the wheel assembly 100 removed. FIG. 1A illustrates third rim hole 118 and a portion of the third spoke 138 and the fourth rim hole 120 and a portion of the fourth spoke 140.

FIG. 1E illustrates a third angle 210 that may be defined with respect to an axis 212 radially normal to the rim 102 at the location of the third rim hole 118. The third angle 210 may have a first component 210A and a second component 210B. Second component 210B may be associated with the axis 212 radially normal to the rim 102 at the location of the third rim hole 118. The second component 210B of third angle 210 of the third rim hole 118 is measured with respect to axis 212. In a non-limiting example, the second component 210B of the third angle 210 may be between 3.8° and 4.7°, and more specifically the second component 210B of the third angle 210 may be between 3.8° and 4.7° fore with respect to axis 212. Accordingly, the second component 210B of the third angle 210 may be the inverse of the second component 150B of the first angle 150.

Third spoke 138 may extend between third rim hole 118 and third hub hole 128 (see FIG. 2A) along third angle 210 that coaxially aligns the third rim hole 118 and the third hub hole 128. Accordingly, third angle 210 may have a second component as shown in FIG. 1E.

In some embodiments, the first component 210A (not shown) of third angle 210 may be numerically similar to or equal to the first component 150A of first angle 150. Accordingly, FIG. 1B may illustrate the first component 210A of third angle 210, which may be illustrated by first component 150A of angle 150. The first component 210A of third angle 210 is defined in relation to a center line through the rim 102 at the location of the third rim hole 118. Third spoke 138 may be illustrated by first spoke 134 in FIG. 1B, where the third spoke 138 extends through third rim hole 118 along third angle 210. In a non-limiting example, the first component 210A of the third angle 210 may be between 3.5° and 7°, and more specifically the first component 210A of the third angle 210 may be between 3.5° and 7° to the right of centerline at the location of the third rim hole 118 (e.g. illustrated with respect to first component 150A of first angle 150 as center line 152).

FIG. 1E also illustrates a fourth angle 214 that may be defined with respect to an axis 216 radially normal to the rim 102 at the location of the fourth rim hole 120. The fourth angle 214 has a second component 214B associated with the axis 216 radially normal to the rim 102 at the location of the fourth rim hole 120. The second component 214B of angle 214 of the fourth rim hole 120 is measured with respect to axis 216. In a non-limiting example, the second component 214B of the fourth angle 214 may be between 3.8° and 4.7°, and more specifically the second component 214B of the fourth angle 214 may be between 3.8° and 4.7° fore with respect to axis 216. Accordingly, the second component 214B of the fourth angle 214 may be the inverse of the second component 182B of the second angle 182.

Fourth spoke 140 may extend between fourth rim hole 120 and fourth hub hole 130 (see FIG. 2A) along fourth angle 214 that coaxially aligns the fourth rim hole 120 and the fourth hub hole 130. Accordingly, fourth angle 214 may have a second component as shown in FIG. 1E.

In some embodiments, the first component 214A of fourth angle 214 may be numerically similar to or equal to the first component 182A of second angle 182. Accordingly, FIG. 1D may illustrate the first component 214A of fourth angle 214, which may be illustrated by angle 182A. The first component 214A of fourth angle 214 is defined in relation to a center line through the rim 102 at the location of the fourth rim hole 120. Fourth spoke 140 may be illustrated by second spoke 136 in FIG. 1D, where the fourth spoke 140 extends through fourth rim hole 120 along fourth angle 214. In a non-limiting example, the first component 214A of the fourth angle 214 may be between 1.5° and 5.5°, and more specifically the first component 214A of the fourth angle 214 may be between 1.5° and 5.5° to the left of the centerline at the location of the fourth rim hole 120 (e.g. illustrated with respect to the second angle 182 as center line 200).

Although four rim holes 114, 116, 118, 120, four hub holes 124, 126, 128, 130, four spokes 134, 136, 138, 140, and four angles 150, 182, 210, 214 are described herein, it is to be appreciated that any suitable number of rim holes, hub holes, spokes, and angles may be implemented. In some embodiments, the wheel assembly 100 may include rim holes, hub holes, spokes, and angles that are positioned around the circumference of rim 102 and follow the same design parameters described with respect to rim holes 114, 116, 118, 120, hub holes 124, 126, 128, 130, spokes 134, 136, 138, 140, and angles 150, 182, 210, 214 described above. Accordingly, the wheel assembly 100 may include sets of rim holes, hub holes, spokes, and angles that follow the same pattern of rim holes 114, 116, 118, 120, hub holes 124, 126, 128, 130, spokes 134, 136, 138, 140, and angles 150, 182, 210, 214 described above. Accordingly, the wheel assembly 100 may include spokes in sets of four, and wheel assembly may include four spokes, eight spokes, twelve spokes, sixteen spokes, twenty spokes, twenty-four spokes, twenty-eight spokes, and so on. In other embodiments, wheel assembly may include sets of any suitable number, and are not limited to the sets of four described above.

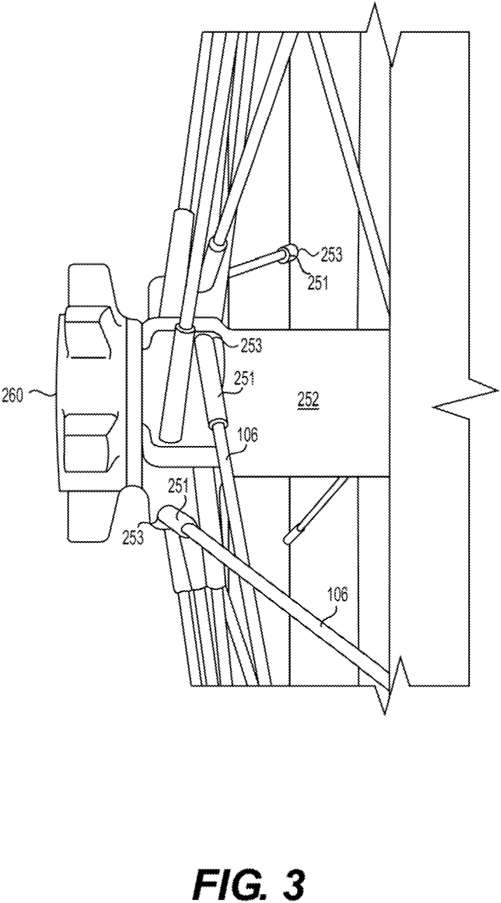

As FIGS. 2B, 3, and 4 illustrate, hub 104 may include flanges 250 extending radially away from the cylindrical internal chamber 122. Each flange 250 may have a plurality of ferrules 251 having hub holes 252 positioned around the circumference of each flange 250. In some embodiments, the plurality of hub holes 251 may include one or more of hub holes 124, 126, 128, 130 described above. In some embodiments, the ferrules 251 may be screw-in ferrules positioned to align the hole in the screw-in ferrule (i.e. hub hole 253) with an associated co-axially aligned rim hole (e.g. rim holes 114, 116, 118, 120 described above). The ferrules 251 and associated hub holes 252 may receive spokes 106 that extend from the hub holes 251 to the respective rim hole. The flanges 250 may be positioned on opposing ends of an axle 252 and may be secured to the axle 252 at their respective positions. The hub 104 may also have an end cap 260 connected to an end of the axle 252.

FIG. 4 specifically illustrates the ferrules 251 and hub holes 252 may include screw-in ferrules positioned to align the hole in the screw-in ferrule (i.e. hub hole 253), and the ferrule 251 may provide the structure surrounding the hub hole (i.e. hub hole 253) that may receive spokes 106 that extend from the hub holes 252 to their respective rim hole. The ferrules 251 and associated hub holes 252 may be positioned on radial extensions 264 of flange 250. The radial extensions 264 may extend outwardly away from flange 250 and may allow for ferrules 251 and hub holes 252 to be positioned on both sides of the radial extensions 264.

FIG. 5 illustrates spoke 106 having an elongated body 300 configured to extend between rim 102 and hub 104. The spoke 106 may include a first threaded end 302 and a second threaded end 304. The first threaded end 302 and the second threaded end 304 may allow spoke 106 to be connectable at both ends to the rim holes (e.g. 114, 116, 118, 120) and the hub holes (e.g. 124, 126, 128, 130, 251). In some embodiments, the first and second threaded ends 302, 304 of spoke 106 may be screwed into the rim holes and/or the hub holes, or the spoke 106 may be screwed into or attached with a fastener 170 at the rim 102 and at hub 252. In some embodiments, ferrules (e.g. ferrules 251) may be bonded to each end of spoke 106. The ferrule (e.g. ferrule 251) may be a metal ferrule that is bonded to the respective ends of spoke 106. The end of ferrule 251 may be threaded and may thread into the hub hole (e.g. hub hole 253), into a rim hole, or into a fastener located on the hub or rim. The ends of spoke 106 may be oppositely threaded, allowing torsion on the spoke to tighten or loosen both ends simultaneously. As one example, threaded end 302 may have a right-hand thread and threaded end 304 may have a left-handed thread. One of the threaded ends 302, 304 may be received and threaded into the hub hole 253 or a hub fastener, and the opposing threaded end 302, 304 may be received and threaded into a rim hole or a rim fastener. Twisting in a first direction tightens on both ends and twisting in a second direction may loosen on both ends. Spoke ends may be metal, plastic, or another suitable material. They may be bonded or glued to the spoke or attached via mechanical means. When ferrules are present, they may be oppositely threaded in the same manner.

In some embodiments, the elongated spoke body 300 may include composite materials. Composite materials may include a standard modulus carbon fiber and/or a high modulus carbon fiber. The carbon fiber composite material may be combined with one or more additional materials. In some embodiments, the elongate body 300 may include fibers blended together that may combine the physical characteristics derived from each of the blended materials. The carbon containing composite material may further include a synthetic fiber. The synthetic fiber may include at least one of nylon 6, polyester, fiberglass, Innegra™ polyolefin, Vactran™, liquid crystal polymer, rayon, Kevlar™, and combinations thereof. In some embodiments, the spoke 106 may include co-mingled fiber materials such as co-mingled fiber -nylon 6. In some embodiments, spoke 106 may include plural carbon fiber materials, the carbon fiber materials may have differing tensile modulus.

In some embodiments, spoke 106 may be configured to have a high tensile strength. In operation, spokes 106 of wheel assembly 102 are placed into a tensile relationship via the connection of the spokes 106 at the rim 102 and the hub 104. As the wheel rotates (e.g. via movement of an attached bicycle, electric bicycle, scooter, cart, or other vehicle), the tensile load shifts across the spokes 106. The combination of materials may provide for improved tensile strength of spokes 106 and may provide for improved performance of wheel assembly 100. For example, the high tensile strength may provide reduced elongation of the spokes which allows for less rim distortion. A reduction in rim distortion may provide improved shape retention of the rim such that the rim can better stay in a round shape that provides improved efficiency while rolling. Furthermore, the inclusion of a combination of materials in the spoke may prevent the spoke from separating in case of a spoke break. For example, the combination of materials may break or partially break, and may still operate in a tensile arrangement between the rim and hub. Additionally, because of reduced elongation of the spokes, the axial perpendicularity of hub to rim is maintained by not allowing the rim to move off axis, as conventional (e.g. metal) spokes may. In some embodiments, a spoke may be provided with significantly less elongation under tensile loads than metal spokes, resulting in a wheel that maintains trueness of shape without significant movement within the wheel. This may result in a stiffer, wheel both axially and torsionally.

The tensile arrangement may be provided by the straight alignment between the rim holes and hub holes. The straight alignment may provide a straight pull from the hub to the location on the rim, and may place all forces in direct line with the hub, thereby creating a pure tensile pull. The composite materials exhibit improved performance when placed in a in pure tensile setup as described.

Further, the use of carbon rims has caused an increase in accidents due to stresses imparted on bent spokes, including bent composite spokes. By eliminating stresses imparted onto bent spokes with the provided embodiments, the safety of the wheel assemblies has also been improved. Conventional spokes may bend or break due to stress risers.

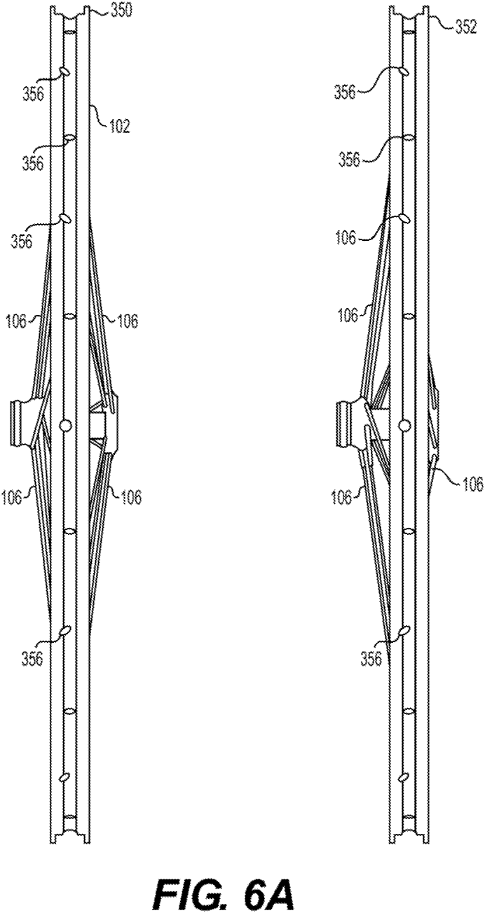

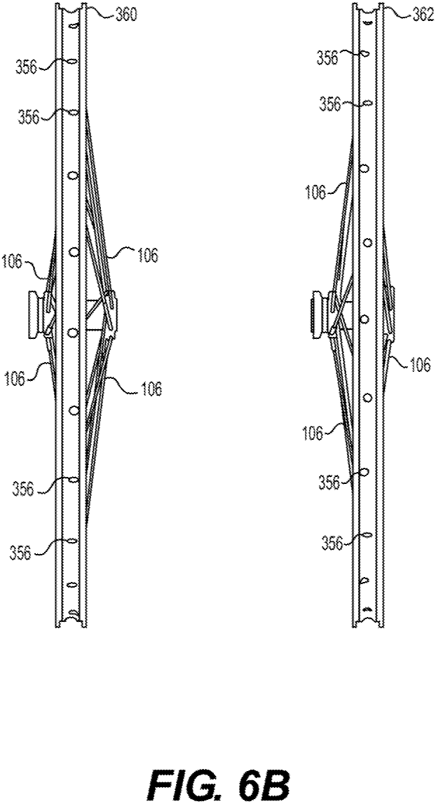

FIG. 6A illustrates top views of front wheel assemblies and back wheel assemblies. Front wheel assembly 350 and back wheel assembly 352 may include the features of wheel assembly 100 described above and may include the same arrangement of parts or may differ. Rim holes 356 may extend through the rims and may be positioned at varied angles through rim. In some embodiments, rim holes 356 may be rim holes 114, 116, 118, 120. For example, front wheel assembly 350 may include spokes 106 that extend at angles outward from a center line of rim 102 on both sides of rim 102. In some embodiments, each side may have the same outward angle, while in other embodiments, the angles may be varied. The back wheel assembly 352 may include spokes 106 that extend at angles outward from a center line of rim 102 on both sides of rim 102. In some embodiments, the spokes 106 on a drive side of the back wheel 352 may have a larger outward angle than the spokes 106 on the non-drive side.

FIG. 6B illustrates top views of front wheel assemblies and back wheel assemblies. Front wheel assembly 360 and back wheel assembly 362 may include the features of wheel assembly 100 described above and may include the same arrangement of parts or may differ. Rim holes 356 may extend through the rims and may be positioned at varied angles through rim. In some embodiments, rim holes 356 may be rim holes 114, 116, 118, 120. For example, front wheel assembly 360 may include spokes 106 that extend at angles outward from a center line of rim 102 on both sides of rim 102. In some embodiments, each side may have the same outward angle, while in other embodiments, the angles may be varied. The back wheel assembly 362 may include spokes 106 that extend at angles outward from a center line of rim 102 on both sides of rim 102. In some embodiments, the spokes 106 on a drive side of the back wheel 362 may have a larger outward angle than the spokes 106 on the non-drive side.

In some embodiments, the hub 104 may be asymmetrical with respect to the centerline of rim 102. As shown in FIGS. 6A and 6B, spokes 106 may extend outwardly from the center line of the rim an may define a V-shape on either side of the hub 104.

In some embodiments, spokes 106 may cross each other in a radial direction and in an axial direction. For example, FIG. 1A illustrates spokes 106 that may cross over each other radially. In some embodiments, each spoke 106 (and spokes 134, 136, 138, 140) may radially cross other spokes twice between hub 104 and rim 102. Spokes 106 (and spokes 134, 136, 138, 140) may radially cross other spokes, but do not interlace with other spokes or come into contact with other spokes. Accordingly, each spoke 106 is not sharing a load (e.g. tensile load) with other spokes via interlaced contact. Spokes 106 may also cross other spokes in an axial direction as illustrated in FIGS. 6A and 6B. The crossing of spokes 106 in a radial direction and an axial direction may generate additional torsional strength for the wheel assemblies.

In some embodiments, a method of assembling a wheel may be provided. The method may include providing a rim (e.g. rim 102), forming a plurality of rim holes extending through the rim at a plurality of angles. Each of the plurality of angles (e.g. angles 150, 182, 210, 214) is defined with respect to an axis normal to the rim at the respective location of each of the plurality of rim holes (e.g. axes 150, 184, 212, 216), the plurality of angles each having a first component (e.g. 150A, 182A, 210A, 214A) and a second component (e.g. 150B, 182B, 210B, 214B).

The method may further include providing a hub (e.g. hub 104), the hub may include a plurality of hub holes (e.g. hub holes 124, 126, 128, 130, 253) having a the plurality of angles aligned with the plurality of angles of the rim holes such that the plurality of rim holes are each aligned with the respective hub holes. The method may further include connecting a plurality of spokes (e.g. spokes 106, 134, 136, 138. 140) at a proximal end to the plurality of hub holes; and extending each of the plurality of spokes along the angle aligning each respective hole to connect connecting the plurality of spokes at a distal end to the plurality of rim holes. Each connected spoke may define a straight line along the angle between the hub hole and the rim hole.

### EXAMPLES

The following examples are provided as exemplary, non-limiting examples for the wheel assembly 100 described herein. In some embodiments, the wheel assembly 100 may have the following first angle components, second angle components, and offset distances from the rim center line:

| | | | | |
|---|---|---|---|---|
| | Hole Number | First Component Of Angle | Second Component Of Angle | Offset From Rim Center Line |
| ASSEMBLY 1 | Hole 1 | 5° right | 4.3° aft | 1 mm left |
| | Hole 2 | 2° left | 4.3° aft | 1 mm right |
| | Hole 3 | 5° right | 4.3° fore | 1 mm left |
| | Hole 4 | 2° left | 4.3° fore | 1 mm right |

| | | | | |
|---|---|---|---|---|
| | Hole Number | First Component Of Angle | Second Component Of Angle | Offset From Rim Center Line |
| ASSEMBLY 2 | Hole 1 | 4° right | 4.3° aft | 1.5 mm left |
| | Hole 2 | 2° left | 4.3° aft | 1.5 mm right |
| | Hole 3 | 4° right | 4.3° fore | 1.5 mm left |
| | Hole 4 | 2° left | 4.3° fore | 1.5 mm right |

| | | | | |
|---|---|---|---|---|
| | Hole Number | First Component Of Angle | Second Component Of Angle | Offset From Rim Center Line |
| ASSEMBLY 3 | Hole 1 | 6.5° right | 4.5° aft | 2 mm left |
| | Hole 2 | 4.9° left | 4.5° aft | 2 mm left |
| | Hole 3 | 6.5° right | 4.5° fore | 2 mm left |
| | Hole 4 | 4.9° left | 4.5° fore | 2 mm left |

| | | | | |
|---|---|---|---|---|
| | Hole Number | First Component Of Angle | Second Component Of Angle | Offset From Rim Center Line |
| ASSEMBLY 4 | Hole 1 | 6.5° right | 4.0° aft | 2 mm left |
| | Hole 2 | 4.4° left | 4.0° aft | 2 mm left |
| | Hole 3 | 6.5° right | 4.0° fore | 2 mm left |
| | Hole 4 | 4.4° left | 4.0° fore | 2 mm left |

In some embodiments, assembly 1 may be used with a rim that is 36 mm deep and 21 mm wide. Assembly 2 may be used with a rim that is 46 mm deep and 21 mm wide. Assembly 3 may be used with rims that are 23 mm deep and 25 mm wide or that are 25 mm deep and 30 mm wide. Assembly 4 may be used with rims that are 28 mm deep and 22 mm wide.

Exemplary embodiments of this disclosure may include:

1. A wheel assembly (100) comprising:
a rim (102) comprising a first rim hole (114) extending through an inner surface (108) and an outer surface (110, 142) of the rim at a first angle (150), the first angle (150) being defined with respect to a center line (152) through the wheel in a direction of travel at the location of the first rim hole (114) and with respect to an axis (180) radially normal to the rim (102), the first angle (150) having a non-zero first component (150A) relative to the center line (152) and a non-zero second component (150B) relative to the radially normal axis (180);
a hub (104) comprising a first hub hole (124), the first hub hole (124) being formed at the first angle (150) such that the first rim hole (114) and the first hub hole (124) are co-axial; and
a first spoke (134) extending between the first rim hole (114) and the first hub hole (124), the first spoke (134) being co-axial with the first rim hole (114) and the first hub hole (124).

2. The wheel assembly of embodiment 1, further comprising:
a second rim hole (116) extending through the rim (102) at a second angle (182), the second angle (182) is defined with respect to a center line (200) through the wheel in a direction of travel at the location of the second rim hole (116) and with respect to the axis (184) normal to the rim (102) at the location of the second rim hole (116), the second angle (182) having a non-zero first component (182A) relative to the center line (162) and a non-zero second component (182B) relative to the radially normal axis (184);
a second hub hole (126) at the second angle (182) such that the second rim hole (116) and the second hub hole (126) are aligned;
a second spoke (136) extending between the second rim hole (116) and the second hub hole (126).

3. The wheel assembly according to embodiments 1 or 2, further comprising:
a third rim hole (118) extending through the rim at the first angle (150) in the direction of the first component (150A) and the inverse of the first angle (150) in the direction of the second component (150B) at the location of the third rim hole (118) ;
a third hub hole (128) at the first angle in the direction of the first component and the inverse of the first angle in the direction of the second component such that the third rim hole (118) and the third hub hole (128) are aligned;
a third spoke (138) extending between the third rim hole (118) and the third hub hole (128).

4. The wheel assembly according to any of the preceding embodiments, further comprising:
a fourth rim hole (120) extending through the rim at the second angle (182) in the direction of the first component (182A) and the inverse of the second angle (182) in the direction of the second component (182B) at the location of the fourth rim hole (120);
a fourth hub hole (130) at the second angle (182) in the direction of the first component (182A) and the inverse of the second angle (182) in the direction of the second component (182B) such that the fourth rim hole (120) and the fourth hub hole (130) are aligned;
a fourth spoke (140) extending between the fourth rim hole (120) and the fourth hub hole (130).

5. The wheel assembly according to any of the preceding embodiments, wherein:
the first component (150A) of the first angle (150) is between 3.5° and 7°;
the first component (182A) of the second angle (182) is between 1.5° and 5.5°;
the second component (150B) of the first angle (150) and the second angle (182B) is between 3.8° and 4.7°.

6. The wheel assembly according to any of the preceding embodiments, wherein the spokes (106, 134, 136, 138, 140) are threaded at both ends (302, 304) and are connectable at the rim holes (114, 116, 118, 120) and the hub holes (124, 126, 128, 130).

7. The wheel assembly according to any of the preceding embodiments, wherein the first rim hole (114) is offset from the axis normal (180) to the rim at the location of the first rim hole (114).

8. A wheel assembly (100) comprising:
a rim comprising a first rim hole (114) extending through the rim at a first angle (150), the first angle (150) is defined with respect to a center line (152) through the wheel in a direction of travel at the location of the first rim hole (114) and with respect to an axis (180) radially normal to the rim (102), the first angle (150) having a first component (150A) associated with the center line (152) and a second component (152B) associated with the radially normal axis(180) ;
a hub (104) comprising a first hub hole (124) at the first angle (150) such that the first rim hole (114) and the first hub hole (124) are co-axial
a first spoke (134) extending between the first rim hole (114) and the first hub hole (124), the first spoke (134) comprising a carbon containing composite material.

9. The wheel assembly according to any of the preceding embodiments, wherein the carbon containing composite material further comprises a synthetic fiber.

10. The wheel assembly according to any of the preceding embodiments, wherein the synthetic fiber comprises at least one of nylon 6, polyester, fiberglass, Innegra™ polyolefin, Vactran™, liquid crystal polymer, rayon, Kevlar™, and combinations thereof.

11. The wheel assembly according to any of the preceding embodiments, wherein the spoke (106, 134, 136, 138, 140) comprises co-mingled fiber materials.

12. The wheel assembly according to any of the preceding embodiments, wherein the spoke (106, 134, 136, 138, 140) comprises plural carbon fiber materials, the carbon fiber materials having differing tensile modulus.

13. A method of assembling a wheel, the method comprising:
providing a rim (102), the rim comprising a plurality of rim holes (114, 116, 118, 120) extending through the rim (102) at a plurality of angles (150, 182, 210, 214), each of the plurality of angles (150, 182, 210, 214) is defined with respect to an axis (180, 184, 210, 214) normal to the rim (102) at the respective location of each of the plurality of rim holes (114, 116, 118, 120), the plurality of angles (150, 182, 210, 214) each having a first component (150A, 182A, 210A, 214A) defined with respect to the center line (152, 200) and a second component (150B, 182B, 210B, 214B) defined with respect to the radially normal axis (180, 184, 210, 214);
providing a hub (104), the hub comprising a plurality of hub holes (124, 126, 128, 130) the plurality of angles (150, 182, 210, 214) of the rim holes such that the plurality of rim holes (114, 116, 118, 120) are each aligned with the respective hub holes (124, 126, 128, 130);
connecting a plurality of spokes (106, 134, 136, 138, 140) at a proximal end to the plurality of hub holes (124, 126, 128, 130); and
extending each of the plurality of spokes (106, 134, 136, 138, 140) along the angle (150, 182, 210, 214) aligning each respective hole to connect connecting the plurality of spokes (106, 134, 136, 138, 140) at a distal end to the plurality of rim holes (114, 116, 118, 120).

14. The method according to embodiment 13, wherein each connected spoke (106, 134, 136, 138, 140) defines a straight line along the angle between the hub hole (124, 126, 128, 130)and the rim hole (114, 116, 118, 120).

15. A wheel spoke (106) comprising:
an elongated body (300) configured to extend between a rim (102) and a wheel hub (104), the elongated body comprising a high modulus carbon fiber and a blended synthetic material;
a first threaded end (302); and
a second threaded end (304).

16. The wheel spoke of embodiment 15 , wherein the first end (302) and the second end (304) are metal and are bonded to the composite.

17. The wheel spoke of embodiment 15 or 16, wherein the first end (302) and the second end (304) comprise ferrules (251).

18. The wheel spoke of embodiments 15, 16, or 17, wherein the first end (302) and the second end (304) are oppositely threaded.

It should be noted that the products and/or processes disclosed may be used in combination or separately. Additionally, exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the prior detailed description be considered as exemplary only, with the true scope and spirit being indicated by the following claims.

The examples presented herein are for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

What is claimed is:

1. A wheel assembly comprising:
a rim comprising a first rim hole extending through an inner surface and an outer surface of the rim at a first angle, the first angle being defined with respect to a center line through the wheel in a direction of travel at the location of the first rim hole and with respect to an axis radially normal to the rim, the first angle having a non-zero first component relative to the center line and a non-zero second component relative to the radially normal axis;
a hub comprising a first hub hole, the first hub hole being formed at the first angle such that the first rim hole and the first hub hole are co-axial; and
a first spoke extending between the first rim hole and the first hub hole, the first spoke being co-axial with the first rim hole and the first hub hole.

2. The wheel assembly of claim 1, further comprising:
a second rim hole extending through the rim at a second angle, the second angle is defined with respect to a center line through the wheel in a direction of travel at the location of the second rim hole and with respect to the axis normal to the rim at the location of the second rim hole, the second angle having a non-zero first component relative to the center line and a non-zero second component relative to the radially normal axis;
a second hub hole at the second angle such that the second rim hole and the second hub hole are aligned;
a second spoke extending between the second rim hole and the second hub hole.

3. The wheel assembly of claim 2, further comprising:
a third rim hole extending through the rim at the first angle in the direction of the first component and the inverse of the first angle in the direction of the second component at the location of the third rim hole;
a third hub hole at the first angle in the direction of the first component and the inverse of the first angle in the direction of the second component such that the third rim hole and the third hub hole are aligned;
a third spoke extending between the third rim hole and the third hub hole.

4. The wheel assembly of claim 3, further comprising:
a fourth rim hole extending through the rim at the second angle in the direction of the first component and the inverse of the second angle in the direction of the second component at the location of the fourth rim hole;
a fourth hub hole at the second angle in the direction of the first component and the inverse of the second angle in the direction of the second component such that the fourth rim hole and the fourth hub hole are aligned;
a fourth spoke extending between the fourth rim hole and the fourth hub hole.

5. The wheel assembly of claim 4, wherein:
the first component of the first angle is between 3.5° and 7°;
the first component of the second angle is between 1.5° and 5.5°;
the second component of the first angle and the second angle is between 3.8° and 4.7°.

6. The wheel assembly of claim 4, wherein the spokes are threaded at both ends and are connectable at the rim holes and the hub holes.

7. The wheel assembly of claim 4, wherein the first rim hole is offset from the axis normal to the rim at the location of the first rim hole.

8. A wheel assembly comprising:
a rim comprising a first rim hole extending through the rim at a first angle, the first angle is defined with respect to a center line through the wheel in a direction of travel at the location of the first rim hole and with respect to an axis radially normal to the rim, the first angle having a first component associated with the center line and a second component associated with the radially normal axis;
a hub comprising a first hub hole at the first angle such that the first rim hole and the first hub hole are co-axial
a first spoke extending between the first rim hole and the first hub hole, the first spoke comprising a carbon containing composite material.

9. The wheel assembly of claim 8, wherein the carbon containing composite material further comprises a synthetic fiber.

10. The wheel assembly of claim 9, wherein the synthetic fiber comprises at least one of nylon 6, polyester, fiberglass, Innegra™ polyolefin, Vactran™, liquid crystal polymer, rayon, Kevlar™, and combinations thereof.

11. The wheel assembly of claim 8, wherein the spoke comprises co-mingled fiber materials.

12. The wheel assembly of claim 10, wherein the spoke comprises plural carbon fiber materials, the carbon fiber materials having differing tensile modulus.

13. A method of assembling a wheel, the method comprising:
providing a rim, the rim comprising a plurality of rim holes extending through the rim at a plurality of angles, each of the plurality of angles is defined with respect to an axis normal to the rim at the respective location of each of the plurality of rim holes, the plurality of angles each having a first component defined with respect to the center line and a second component defined with respect to the radially normal axis;
providing a hub, the hub comprising a plurality of hub holes the plurality of angles of the rim holes such that the plurality of rim holes are each aligned with the respective hub holes;
connecting a plurality of spokes at a proximal end to the plurality of hub holes; and
extending each of the plurality of spokes along the angle aligning each respective hole to connect connecting the plurality of spokes at a distal end to the plurality of rim holes.

14. The method according to claim 13, wherein each connected spoke defines a straight line along the angle between the hub hole and the rim hole.

15. A wheel spoke comprising:
an elongated body configured to extend between a rim and a wheel hub, the elongated body comprising a high modulus carbon fiber and a blended synthetic material;
a first threaded end; and
a second threaded end.

16. The wheel spoke of claim 15 , wherein the first end and the second end are metal and are bonded to the composite.

17. The wheel spoke of claim 16, wherein the first end and the second end are oppositely threaded.

18. The wheel assembly of claim 12, wherein
the spoke has a first threaded end and a second threaded end,
the first threaded end is secured to a fastener at the rim, and
the second threaded end is secured to the hub hole.

19. The wheel assembly of claim 18, wherein
the first threaded end and the second threaded end are oppositely threaded ferrules, and
the ferrules are bonded to the spoke.
